(19) United States
(12) Patent Application Publication
(10) Pub. No.: US 2008/0168302 A1
(43) Pub. Date: Jul. 10, 2008

(54) SYSTEMS AND METHODS FOR DIAGNOSING FAULTS IN A MULTIPLE DOMAIN STORAGE SYSTEM

(75) Inventors: Brian J. Cagno, Tucson, AZ (US); Carl E. Jones, Tucson, AZ (US); Gregg S. Lucas, Tucson, AZ (US); Thomas S. Truman, Tucson, AZ (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/621,686

(22) Filed: Jan. 10, 2007

(51) Int. Cl. G06F 11/00

(52) U.S. Cl. 714/5; 714/47

(57) ABSTRACT

Systems and methods for diagnosing faults in a multiple domain storage system. Exemplary embodiments include a system for diagnosing faults, the system including independent servers coupled to a serial attached SCSI switch module, end devices coupled to the serial attached SCSI module, at least one external cable connected between the serial attached SCSI module and the plurality of end devices, wherein the external cable defined an external fabric between the serial attached SCSI module and the plurality of end devices; and a process residing on the external fabric, the process having instructions to disable a high speed serializer/deserializer residing on each of the plurality of end devices, enable a universal asynchronous receiver/transmitter interface residing on each of the plurality of end devices, send and receive single ended data and in response to a complete data transfer, disabling the universal asynchronous receiver/transmitter interface and enabling the high speed serializer/deserializer.

### TRADEMARKS

IBM® and BladeCenter® are registered trademarks of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to storage network systems, and particularly to systems and methods for diagnosing faults in a multiple domain storage system.

2. Description of Background

In Storage Network systems, such as Storage Blades in BladeCenter, as well as IBM's Enterprise DS6000 and DS8000 systems, high speed serial interfaces are employed to interconnect storage enclosures. Both Fiber Channel and Serial Attached SCSI are such serial interfaces. These interfaces and protocols are standardized whereby all communication is accomplished “inband” over the high speed interface, that is, there is no supplemental interface (out of band) that is available for additional communication paths. FIG. 1 illustrates a typical BladeCenter configuration employing high speed serial attached SCSI (SAS) interfaces between the storage enclosures. In general, system 100 includes multiple server blades 110 coupled to a SAS switch module 120 via internal fabric 105. Switch module 120 is in turn coupled to multiple switched bunch of disks (SBOD) 130 via external fabric 125.

When a high speed interface fails it becomes difficult to diagnose and isolate the failure. If the interface is failed, then it cannot be relied upon to further diagnose the problem, on the far end of the configuration. Likewise, the cable itself cannot be verified. Generally, the suspect components are the interconnecting cable and both end of the interface, such as storage controllers. These are referred to as Field Replaceable Units (FRUs). Inadequate fault isolation can result in replacing more than a single FRU, which adds time and cost to the repair action by the customer. Therefore, a need exists to be able to reliably detect and isolate faults on a high speed interface that is failed, by using the failed interface itself.

### SUMMARY OF THE INVENTION

Exemplary embodiments include a system having multiple domain storage and for diagnosing faults, the system including a plurality of independent servers coupled to a serial attached SCSI switch module, a plurality of end devices coupled to the serial attached SCSI module, at least one external cable connected between the serial attached SCSI module and the plurality of end devices, wherein the external cable defined an external fabric between the serial attached SCSI module and the plurality of end devices; and a process residing on the external fabric, the process having instructions to disable a high speed serializer/deserializer residing on each of the plurality of end devices, enable a universal asynchronous receiver/transmitter interface residing on each of the plurality of end devices, send and receive single ended data and in response to a complete data transfer, disabling the universal asynchronous receiver/transmitter interface and enabling the high speed serializer/deserializer.

Additional embodiments include a method for diagnosing faults in a multiple domain storage system, the method including providing a cable connection between a plurality of independent servers and a plurality of end devices in the multiple domain storage system, disabling a high speed serializer/deserializer residing on each of the plurality of independent servers and each of the plurality of end devices, enabling a universal asynchronous receiver/transmitter interface residing on each of the plurality of independent servers and each of the plurality of end devices, sending and receiving single ended data and in response to a complete data transfer, disable the universal asynchronous receiver/transmitter interface and enable the high speed serializer/deserializer.

Further embodiments include a computer readable medium having computer executable instructions for performing a method for diagnosing faults in a multiple domain storage system, the method including providing a cable connection between a plurality of independent servers and a plurality of end devices in the multiple domain storage system, disabling a high speed serializer/deserializer residing on each of the plurality of independent servers and each of the plurality of end devices, enabling a universal asynchronous receiver/transmitter interface residing on each of the plurality of independent servers and each of the plurality of end devices, sending and receiving single ended data and in response to a complete data transfer, disable the universal asynchronous receiver/transmitter interface and enable the high speed serializer/deserializer.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically systems and methods for diagnosing faults in a multiple domain storage system have been achieved.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a typical storage network configuration employing high speed SAS interfaces between the storage enclosures;

FIG. 2 illustrated an exemplary embodiment of a high speed interface in a SAS storage network;

FIG. 3A illustrates an exemplary embodiment of a standard communication path implementing two differential wire pairs in a communication interface;

FIG. 3B illustrates an exemplary embodiment of a redundant communication path implementing two independent single ended pairs in a communication interface;

FIG. 4 illustrates an exemplary embodiment of a redundant communication path 410 implementing four independent single ended paths 415 in a communication interface; and

FIG. 5 illustrates a method 500 for switching between a high speed differential mode and a single ended diagnostic mode in accordance with exemplary embodiments.

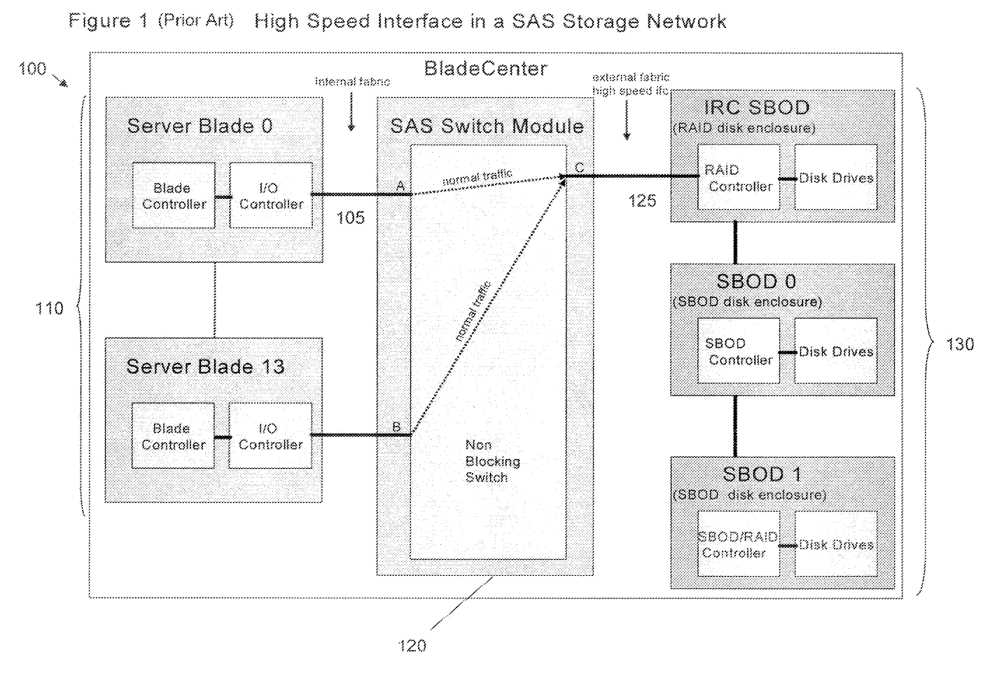

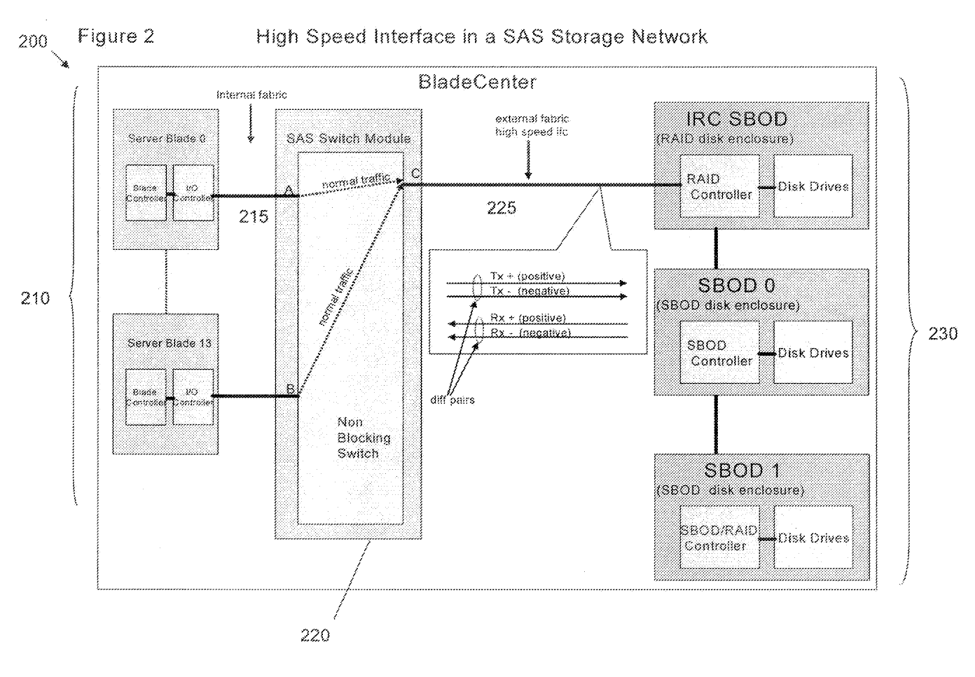

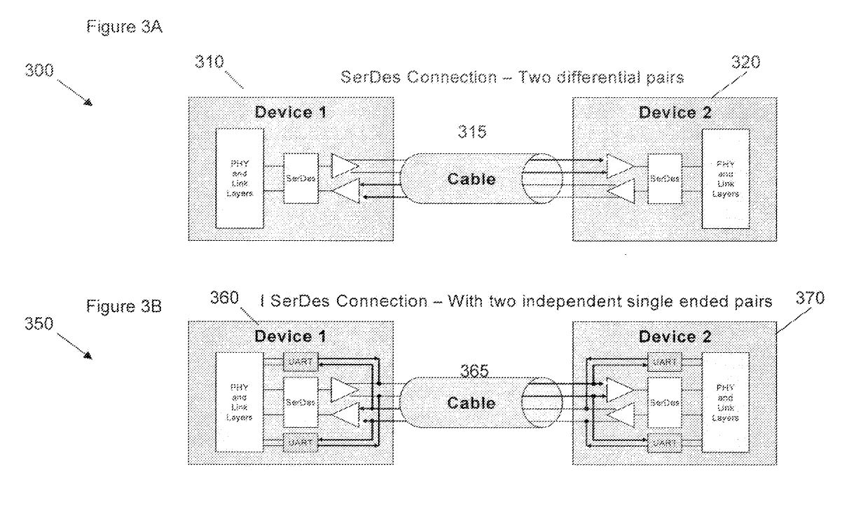

The detailed description explains the preferred embodiments of the invention, together with advantages and features, by way of example with reference to the drawings.

### DETAILED DESCRIPTION OF THE INVENTION

Exemplary embodiments include a high speed differential interface that includes four wires. Two wires are used differentially to represent a single signal, such as a transmit signal. Similarly, the other two wires are used differentially to represent a second single signal such as a receive signal. In this fashion, transmit and receive signals are implemented. In exemplary implementations, the system and methods described herein provide a mechanism to operate the four signal wires as single ended signals which in turn provides four discrete signals. As such, redundant communication paths are provided. In general, each path includes two wires such as the traditional universal asynchronous receiver/transmitter (UART) interface. In other exemplary implementations, other interfaces such as I²C or 1-wire could be likewise implemented. By allowing for a fault tolerant communication path it is now possible to isolate a fault down to a single FRU whereas previously the isolation could only be isolated to three FRUs. For instance, once communication is lost on the high speed interface and the newly invented method is used to switch to single ended links an intelligent path still exists. If still no communication is possible, than the failure is most likely in the cable. If only one way communication is possible the failure is on one of the controller cards.

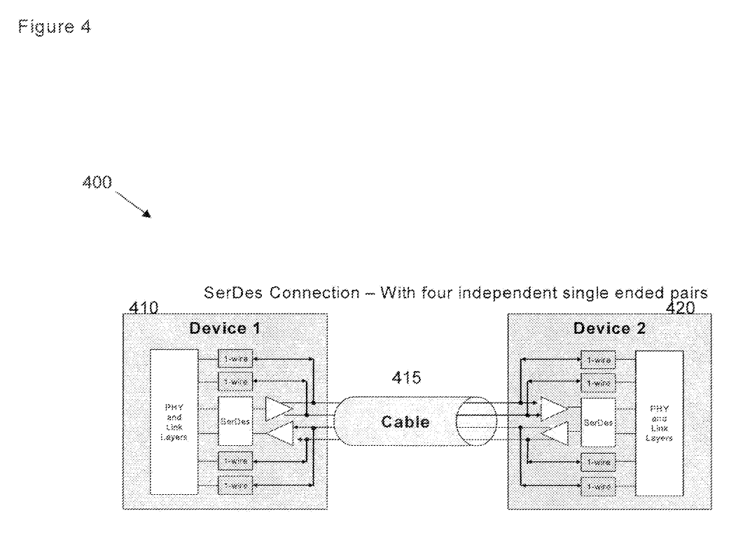

FIG. 4 illustrates an exemplary embodiment of a redundant communication path 410 implementing four independent single ended pairs 415 in a communication interface. Two devices 410, 420 are coupled to one another via quad 1-wire interfaces, Each path includes two wires, implemented as four 1-wire bidirectional interfaces, thereby having four single ended signals, each being independent from the other. Any single failure on the cabled interface or within the SERDES functions on either side of the interface can be tolerated while still providing reliable bidirectional interface communication for diagnosing the fault condition. This implementation provides maximum tolerance to interface failures, i.e. can tolerate failure of up to three of the four interfaces. This additional benefit comes at a cost of adding circuitry and complexity to the interface functions.

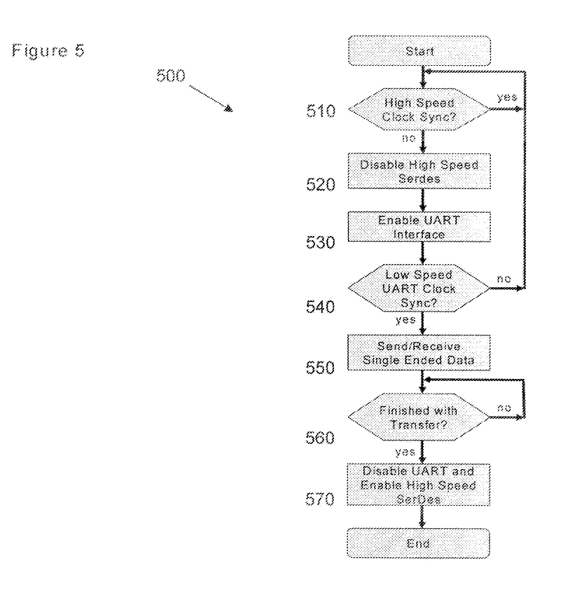

Given that the high speed interface has no out-of-band communication paths, a novel automatic mechanism is provided to switch between the normal high speed differential mode and the single ended diagnostic mode. FIG. 5 illustrates a method 500 for switching between a high speed differential mode and a single ended diagnostic mode in accordance with exemplary embodiments. At step 510 it is determined whether or not the system is operating in high speed clock synchronization. If the system is operating in high speed clock synchronization, then the method continues to loop until the system is not operating in high speed clock synchronization. Then at step 520, the high speed SERDES are disabled. At step 530, the UART interface is enabled. At step 540, it is determined whether or not the system is operating in low speed UART clock synchronization. If not, then the method repeats back to step 510. If the system is operating in low speed UART clock synchronization, then at step 560, it is determined whether or not the diagnostic transfer is complete. If the transfer is complete, then at step 570, the UART is disabled and the high speed SERDES is enabled.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A system having multiple domain storage and for diagnosing faults, the system comprising:
a plurality of independent servers coupled to a serial attached SCSI switch module;
a plurality of end devices coupled to the serial attached SCSI module;
at least one external cable connected between the serial attached SCSI module and the plurality of end devices, wherein the external cable defined an external fabric between the serial attached SCSI module and the plurality of end devices; and
a process residing on the external fabric, the process having instructions to:
disable a high speed serializer/deserializer residing on each of the plurality of end devices;
enable a universal asynchronous receiver/transmitter interface residing on each of the plurality of end devices;
send and receive single ended data; and
in response to a complete data transfer, disabling the universal asynchronous receiver/transmitter interface and enabling the high speed serializer/deserializer.

2. The system as claimed in claim 1 wherein the plurality of end devices are switched bunch of disks.

3. The system as claimed in claim 2 wherein each switched bunch of disks includes a disk drive coupled to at least one of a redundant array of inexpensive disks controller and a switched bunch of disks controller.

4. The system as claimed in claim 3 wherein the at least one external cable comprises two independent single ended pairs of wires.

5. The system as claimed in claim 4 wherein each of the two independent single ended pairs of wires is coupled to a respective UART on the end device and on the each of the plurality of independent servers.

6. The system as claimed in claim 5 wherein a single failure on at least one of the external cable and the serializer/deserializer of the independent servers and the end devices is tolerated and provides interface communication for diagnosing the fault condition.

7. The system as claimed in claim 3 wherein the at least one external cable comprises four independent single ended pairs of wires.

8. The system as claimed in claim 7 wherein each of the four independent single ended pairs of wires is coupled to a respective one-wire bi-directional interface on the end device and on the each of the plurality of independent servers.

9. The system as claimed in claim 8 wherein a single failure on at least one of the external cable and the serializer/deserializer of the independent servers and the end devices is tolerated and provides interface communication for diagnosing the fault condition.

10. A method for diagnosing faults in a multiple domain storage system, the method comprising:
providing a cable connection between a plurality of independent servers and a plurality of end devices in the multiple domain storage system;
disabling a high speed serializer/deserializer residing on each of the plurality of independent servers and each of the plurality of end devices;
enabling a universal asynchronous receiver/transmitter interface residing on each of the plurality of independent servers and each of the plurality of end devices;
sending and receiving single ended data; and
in response to a complete data transfer, disable the universal asynchronous receiver/transmitter interface and enable the high speed serializer/deserializer.

11. The method as claimed in claim 10 further comprising determining the presence of a high speed clock synchronization.

12. The method as claimed in claim 11 wherein the high speed serializer/deserializer is disabled in response to the lack of presence of the high speed clock synchronization.

13. The method as claimed in claim 12 further comprising determining the presence of a low speed universal asynchronous receiver/transmitter clock synchronization in response to the enabling of the universal asynchronous receiver/transmitter interface.

14. The method as claimed in claim 13 wherein the single ended data is sent in response to the presence of the low speed universal asynchronous receiver/transmitter clock synchronization.

15. The method as claimed in claim 14 wherein the determination of the presence of high speed clock synchronization is repeated if there is not a presence of low speed universal asynchronous receiver/transmitter clock synchronization.

16. A computer readable medium having computer executable instructions for performing a method for diagnosing faults in a multiple domain storage system, the method comprising:
providing a cable connection between a plurality of independent servers and a plurality of end devices in the multiple domain storage system;
disabling a high speed serializer/deserializer residing on each of the plurality of independent servers and each of the plurality of end devices;
enabling a universal asynchronous receiver/transmitter interface residing on each of the plurality of independent servers and each of the plurality of end devices;
sending and receiving single ended data; and
in response to a complete data transfer, disable the universal asynchronous receiver/transmitter interface and enable the high speed serializer/deserializer.

17. The computer readable medium as claimed in claim 16 wherein the method further comprises determining the presence of a high speed clock synchronization, wherein the high speed serializer/deserializer is disabled in response to the lack of presence of the high speed clock synchronization.

18. The computer readable medium as claimed in claim 17 wherein the method further comprises determining the presence of a low speed universal asynchronous receiver/transmitter clock synchronization in response to the enabling of the universal asynchronous receiver/transmitter interface.

19. The computer readable medium as claimed in claim 18 wherein the single ended data is sent in response to the presence of the low speed universal asynchronous receiver/transmitter clock synchronization.

20. The computer readable medium as claimed in claim 19 wherein the determination of the presence of high speed clock synchronization is repeated if there is not a presence of low speed universal asynchronous receiver/transmitter clock synchronization.
